(19) United States
(12) Patent Application Publication
(10) Pub. No.: US 2005/0174645 A1
(43) Pub. Date: Aug. 11, 2005

(54) Vehicle mirror having polymeric reflective film element and self-dimming element

(75) Inventors: Ian Boddy, Ada, MI (US); Keith D. Foote, Kentwood, MI (US); James A. Ruse, Allegan, MI (US)

Correspondence Address: MCGARRY BAIR PC, 171 MONROE AVENUE, N.W., SUITE 600, GRAND RAPIDS, MI, 49503, US

(73) Assignee: Magna Donnelly Mirrors North America, Kentwood, MI (US)

(21) Appl. No.: 10/512,460

(22) PCT Filed: Apr. 22, 2003
(86) PCT No.: PCT/US03/12416

Related U.S. Application Data
(60) Provisional application No. 60/319,199, filed on Apr. 23, 2002.

(51) Int. Cl. G02B 5/02; G02B 13/20; G02B 7/182

(52) U.S. Cl. 359/599; 359/871

(57) ABSTRACT

A rearview mirror assembly comprises a reflective element, preferably fabricated of a lightweight, rigid, high-strength plastic and a relatively thin reflective film conformably attached thereto. A portion of the reflective element can also comprise a convex surface for monitoring the “blind spot” typically experienced by the driver. A mirror-mounted light assembly, such as for turn signals, can be incorporated into the reflective element. The mirror assembly can also comprise a chromomorphic polymeric element in planar alignment with the reflective element, which can be electrically and/or thermally activated. The chromomorphic polymeric element can change its resident color between transparent and a predetermined activated color to provide a dimming function as a characteristic of the particular chromomorphic polymeric element that is employed.

### CROSS-REFERENCE TO RELATED APPLICATION

This application claims the benefit of U.S. provisional application Ser. No. 60/319,199, filed Apr. 23, 2002, and 60/319,218, filed May 1, 2002, which are incorporated herein in their entirety.

### BACKGROUND OF THE INVENTION

1. Field of the Invention

The invention relates to a rearview mirror for an automotive vehicle. In one aspect, the invention relates to a one-piece mirror element for a rearview mirror. In another aspect, the invention relates to a one-piece mirror element having an integral convex portion. In another aspect, the rearview mirror has an automatic dimming feature performed by a chromomorphic polymer.

2. Description of the Related Art

Side-mounted rearview mirrors for automotive vehicles typically comprise a multi-piece (and multi-layer) mirror element. The mirror element will generally comprise a mounting panel or “glass case” to which a reflective element is attached. The glass case can be fabricated of a rigid, high-strength plastic or a metal such as steel. A reflective element, i.e. the mirror, is fixedly attached to the glass case with an adhesive or a mechanical hold-down assembly. The reflective element typically comprises a piece of glass with a reflective coating on one side, similar to a conventional household mirror. A heating element can also be attached to the glass case for defogging or deicing the reflective element. The mirror element is housed within a mirror housing which is attached to the side of the vehicle. A glass or rigid, impact-resistant clear plastic plate may be attached to the mirror housing to enclose the mirror element and protect it from impact or the weather. A bezel may also be placed over the reflective element to secure the reflective element to the mounting panel, add further protection to the reflective element and/or people adjacent to the vehicle, and improve the appearance of the mirror element.

Manufacture of multi-piece mirror elements involves several separate fabrication and assembly steps, and the complicated fabrication and assembly process can be expensive. Having a mirror with multiple pieces increases the likelihood that one piece may fail or be damaged, thereby increasing the risk that costly repairs or replacement will be necessary. Furthermore, the differential shrinkage rates between the mounting plate and the glass require a design “gap” between these elements to avoid cold weather creating excessive side pressure and hoop stress that may distort and ultimately crack the glass element.

The various components making up the mirror element can be relatively heavy, particularly where several pieces of glass are used. In particular, mms used for trucks, SUVs, and other large vehicles can be quite large and heavy. Heavier mirrors require stronger supporting and mounting components, more robust adjustment actuators, and can contribute to a reduction in the mileage of the vehicle due to the weight of the mirror. Heating elements for defogging or defrosting the mirror must be larger and will consume more energy due to the higher heat capacity of the heavy, multi-piece mirror element.

The use of a plastic mounting panel can give rise to structural imperfections such as “read-through” and waviness which can, in turn, introduce unacceptable optical imperfections in the mirror element. “Read-through” refers to the ability to see underlying geometry on an outer opaque surface due to localized shrink and deformation. This localized shrink and deformation occurs more readily in relatively thick sections of the material. Surfaces with high curvature hide these flaws, but they can be quite noticeable on flat surfaces. With plastics, for example, integral supporting ribs traversing one side of a panel can be seen as a corresponding image on the opposite side of the panel. If the reflective element is a film, this “read-through” image can be seen in the film, distorting the reflection image.

Similarly, deviations from a plane surface, or “waviness,” in the plastic mounting panel can give rise to a non-planar reflective surface, particularly where a reflective film is used, thereby distorting the reflection image.

Rearview mirrors can be provided with a convex mirror for eliminating the “blind zone” experienced by the driver. This generally comprises a separate glass or plastic component, further increasing the fabrication costs and weight of the mirror assembly. Rearview mirrors can also be provided with small light assemblies, such as for turn signals, which are typically mounted to shine through the glass comprising the reflective element. Locating the lights behind the glass will reduce the intensity of the lights due to transmission losses as the light shines through the glass. To compensate, larger, heavier lights having an increased power consumption are necessary.

It has also become common to incorporate an automatic-dimming feature into a rearview mirror, whether provided in an interior windshield-mounted rearview mirror or an exterior vehicular mirror. These so-called automatic-dimming mirrors typically reduce the intensity of transmitted images thereon in order to reduce the glare encountered by a driver of the vehicle, typically during nighttime driving conditions. In order to accomplish this glare-reduction function, an electrochromic mirror element is provided in the rearview mirror which typically comprises a “gel” suspended between a pair of dielectric glass plates which, when the gel is electrified, turn the gel a particular color through an oxidation-reduction reaction, thus filtering out any intense light emitted from the rearview mirror. The mirror is typically interconnected to a controller unit which controls the electrification of the gel between the glass plates, thus providing the “automatic” dimming of the rearview mirror element.

These types of electrochromic mirror elements are typically expensive to manufacture and install. In addition, the gel must be sealed within the glass plates, causing additional expense and repair if the seal fails during use. Further, the glass plates can provide an undesirable amount of weight to a typical rearview mirror assembly since they require a pair of glass plates as well as the remainder of the electrochromic element. Finally, the electrochromic gel is caustic, can be dangerous to handle during manufacture, and users risk exposure to the electrochromic material as a result of its corrosive nature.

### SUMMARY OF THE INVENTION

In one aspect, the invention relates to a vehicular mirror system comprising: a vehicular mirror assembly adapted to be mounted to a vehicle, the vehicular mirror assembly having a reflective element mounted therein and a mounting plate for mounting the reflective element in the vehicular mirror assembly; and said vehicular mirror assembly comprising a chromomorphic polymer-element mounted to the housing and in register with the reflective element, wherein the chromomorphic polymer element is generally transparent in a first state and a translucent color in a second state. Activation of the chromomorphic polymer element thereby performs a dimming function for the reflective element when the chromomorphic polymer element is changed to the second state from the first state.

Various embodiments of the invention are also contemplated. For example, the chromomorphic polymer element can be electrically activated. A controller can be provided for controlling the operation of the chromomorphic polymer element. The chromomorphic polymer element can be electrically connected to the vehicle's electrical power supply. The chromomorphic polymer element can be activated by an electrical current delivered to the chromomorphic polymer element. The chromomorphic polymer element can be thermally activated. A heating element can be provided in register with the chromomorphic polymer element. The heating element can be electrically connected to the vehicle's electrical power supply. The heating element can be heated by an electrical current delivered to the heating element. The chromomorphic polymer element can be activated by the heating of the heating element. The heating element can comprise a heat-generating plastic. The mounting plate can be fabricated of the heat-generating plastic. A transparent element can be provided in register with the chromomorphic polymer element for protection of the chromomorphic polymer element from weather and impact forces.

In another aspect of the invention, the invention relates to a vehicular mirror system comprising: a vehicular mirror assembly adapted to be mounted to a vehicle, the vehicular mirror assembly having a reflective element mounted therein; a mounting plate for mounting the reflective element in the vehicular mirror assembly and comprising an obverse side and a reverse side; and the reflective element comprising a polymeric reflective film conformably attached to the mounting plate to provide a reflection image therein. The reflection image is thereby essentially free of visible distortion.

Various other embodiments of the invention are also contemplated. For example, the polymeric reflective film can be attached to the obverse side of the mounting plate. The polymeric reflective film can be attached to the reverse side of the mounting plate. The mounting plate can comprise a planar surface having minimal imperfections to provide the reflection image that is essentially free of visible distortion. The mounting plate can be fabricated of a plastic. The plastic can be fabricated by a gas-injection process to provide a core having a generally uniform distribution of microscopic voids.

A supplemental reflective surface can be provided on the reflective element. The supplemental reflective surface can comprise a circular, convex surface to provide a “fish-eye” view. A single piece of the polymeric reflective film can form the reflective element and the supplemental reflective surface.

A plurality of lighting elements can extend through the mounting plate to provide light reflected from the reflective surface. The lighting elements can be positioned along the periphery of the supplemental reflective surface. The lighting elements can be light-emitting diodes. A plurality of lighting elements can extend through the mounting plate to provide light through the reflective film.

A heating element can be provided in register with the reflective element for defogging and defrosting the reflective element. The heating element can be a heat-generating plastic. The mounting plate can be fabricated from the heat-generating plastic.

In yet an additional aspect, the invention relates to a vehicular mirror system comprising: a vehicular mirror assembly adapted to be mounted to a vehicle, the vehicular mirror assembly having a reflective element mounted therein; a mounting plate for mounting the reflective element in the vehicular mirror assembly; the reflective element comprising a polymeric reflective film conformably attached to the mounting plate to provide a reflection image therein; and a chromomorphic polymer element mounted to the housing and in register with the reflective element, wherein the chromomorphic polymer element is generally transparent in a first state and a translucent color in a second state; whereby activation of the chromomorphic polymer element performs a dimming function for the reflective element when the chromomorphic polymer element is changed to the second state from the first state, and wherein the reflection image is essentially free of visible distortion.

Various embodiments of the invention are also contemplated. For example, the chromomorphic polymer element can be electrically activated. A controller can be provided for controlling the operation of the chromomorphic polymer element. The chromomorphic polymer element can be electrically connected to the vehicle's electrical power supply. The chromomorphic polymer element can be activated by an electrical current delivered to the chromomorphic polymer element. The chromomorphic polymer element can be thermally activated. A controller can be provided for controlling the operation of the chromomorphic polymer element. A heating element can be provided in register with the chromomorphic polymer element. The heating element can be electrically connected to the vehicle's electrical power supply. The heating element can be heated by an electrical current delivered to the heating element. The chromomorphic polymer element can be activated by the heating of the heating element. The heating element can comprise a heat-generating plastic. The mounting plate can be fabricated of the heat-generating plastic.

A transparent element can be provided in register with the chromomorphic polymer element for protection of the chromomorphic polymer element from weather and impact forces. The polymeric reflective film can be attached to the obverse side of the mounting plate. The polymeric reflective film can be attached to the reverse side of the mounting plate. The mounting plate can comprise a planar surface having minimal imperfections to provide the reflection image that is essentially free of visible distortion. The mounting plate can be fabricated of a plastic. The plastic can be fabricated by a gas-injection process to provide a core having a generally uniform distribution of microscopic voids.

A supplemental reflective surface can be provided in the reflective element The supplemental reflective surface can comprise a circular, convex surface to provide a “fish-eye” view. A single piece of the polymeric reflective film can form the reflective element and the supplemental reflective surface. A plurality of lighting elements can extend through the mounting plate to provide light reflected from the reflective surface. The lighting elements can be positioned along the periphery of the supplemental reflective surface. The lighting elements can be light emitting diodes. A plurality of lighting elements can extend through the mounting plate to provide light through the reflective film. A heating element in register with the reflective element for defogging and defrosting the reflective element. The heating element can be a heat-generating plastic. The mounting plate can be fabricated from the heat-generating plastic.

In another aspect, the invention relates to a vehicular mirror system comprising: a vehicular mirror assembly adapted to be mounted to a vehicle, the vehicular mirror assembly having a first reflective element and a second blind zone reflective element mounted therein; wherein the second blind zone reflective element comprises a polymeric reflective film to provide a reflection image therein.

Various embodiments of the invention are also contemplated. The second blind zone reflective element can further comprise a supplemental reflective surface formed on a mounting plate configured in a circular, convex surface to provide a “fish-eye” view. The first reflective element can further comprise a polymeric reflective film. A single piece of the polymeric reflective film can form both the first and second reflective elements.

### BRIEF DESCRIPTION OF THE DRAWINGS

In the drawings:

FIG. 1 is a perspective view of a first embodiment of a rearview mirror assembly according to the invention.

FIG. 2 is a an exploded view of the rearview mirror assembly of FIG. 1 showing a mirror element according to the invention, an actuator, and a housing assembly.

FIG. 3 is a rear elevational view of the mirror element of FIG. 2.

FIG. 4 is a front elevational view of the mirror element of FIG. 2.

FIG. 5 is a cross-sectional view of the mirror element taken along line 5-5 of FIG. 3.

FIG. 6 is an exploded view of the mirror element of FIG. 2 showing the addition of a bezel to the mirror element.

FIG. 7 is an exploded view from the rear of the mirror element of FIG. 2 having an integral lighting element comprising a second embodiment of the invention.

FIG. 8 is a front elevational view of the mirror element of FIG. 7.

FIG. 9 is a partial sectional view of the mirror element taken along line 9-9 of FIG. 8 showing the integral lighting element.

FIG. 9A is a close-up view of a portion of the integral lighting element of FIG. 9.

FIG. 10 is an exploded, perspective view of a third embodiment of the rearview mirror assembly of FIG. 1.

FIG. 11 is an exploded, perspective view of the rearview mirror assembly of FIG. 10 taken from an orientation opposite to that shown in FIG. 10 showing non-visible surfaces of the rearview mirror assembly with components of a housing for the rearview mirror assembly removed for purposes of clarity.

FIG. 12 is a front, elevational view of the rearview mirror assembly of FIG. 11.

FIG. 13 is a cross-sectional view taken along lines 13-13 of FIG. 12.

FIG. 14 is an exploded, perspective view of a fourth embodiment of the rearview mirror assembly of FIG. 1 comprising a thermally-activated, chromomorphic polymeric element associated with a reflective mirror element, taken from an orientation of a visible surface of the rearview mirror assembly.

FIG. 15 is an exploded, perspective view of the rearview mirror assembly of FIG. 14 taken from an orientation opposite to that shown in FIG. 14 showing non-visible surfaces of the rearview mirror assembly with components of a housing for the rearview mirror assembly removed for purposes of clarity.

FIG. 16 is a front, elevational view of the rearview mirror assembly of FIG. 14.

FIG. 17 is a cross-sectional view taken along lines 17-17 of FIG. 16.

FIG. 18 is an exploded, perspective view of a fifth embodiment of the rearview mirror assembly of FIG. 1 comprising an electrically activated, color changing polymeric element associated with a reflective mirror element, taken from an orientation of a visible surface of the rearview mirror assembly.

FIG. 19 is an exploded, perspective view of the rearview mirror assembly of FIG. 18 taken from an orientation opposite to that shown in FIG. 18 showing non-visible surfaces of the rearview mirror assembly with components of a housing for the rearview mirror assembly removed for purposes of clarity.

FIG. 20 is a front, elevational view of the rearview mirror assembly of FIG. 18.

FIG. 21 is a cross-sectional view taken along lines 21-21 of FIG. 20.

FIG. 22 is an exploded, perspective view a sixth embodiment of the rearview mirror assembly of FIG. 1 comprising a thermally-activated, chromomorphic polymeric element associated with a reflective mirror element taken from an orientation of a visible surface of the rearview mirror assembly.

FIG. 23 is an exploded, perspective view of the rearview mirror assembly of FIG. 22 taken from an orientation opposite to that shown in FIG. 22 showing non-visible surfaces of the rearview mirror assembly with components of a housing for the rearview mirror assembly removed for purposes of clarity.

FIG. 24 is a front, elevational view of the rearview mirror assembly of FIG. 22.

FIG. 25 is a cross-sectional view taken along lines 25-25 of FIG. 24.

FIG. 26 is an exploded, perspective view of a seventh embodiment of the rearview mirror assembly of FIG. 1 an electrically activated, color changing polymeric element associated with a reflective mirror element, taken from an orientation of a visible surface of the rearview mirror assembly.

FIG. 27 is an exploded, perspective view of the rearview mirror assembly of FIG. 26 taken from an orientation opposite to that shown in FIG. 26 showing non-visible surfaces of the rearview mirror assembly with components of a housing for the rearview mirror assembly removed for purposes of clarity.

FIG. 28 is a front, elevational view of the rearview mirror assembly of FIG. 26.

FIG. 29 is a cross-sectional view taken along lines 29-29 of FIG. 28.

FIG. 30 is an exploded, perspective view of an eighth embodiment of the rearview mirror assembly of FIG. 1 comprising a thermally-activated, chromomorphic polymeric element associated with a reflective mirror element, taken from an orientation of a visible surface of the rearview mirror assembly.

FIG. 31 is an exploded, perspective view of the rearview mirror assembly of FIG. 30 taken from an orientation opposite to that shown in FIG. 30 showing non-visible surfaces of the rearview mirror assembly with components of a housing for the rearview mirror assembly removed for purposes of clarity.

FIG. 32 is a front, elevational view of the rearview mirror assembly of FIG. 30.

FIG. 33 is a cross-sectional view taken along lines 33-33 of FIG. 32.

### DESCRIPTION OF THE PREFERRED EMBODIMENT

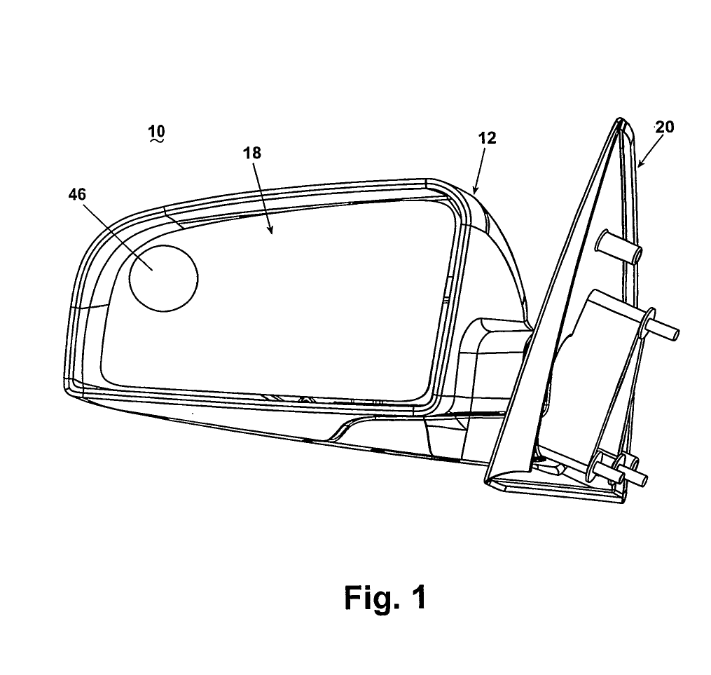

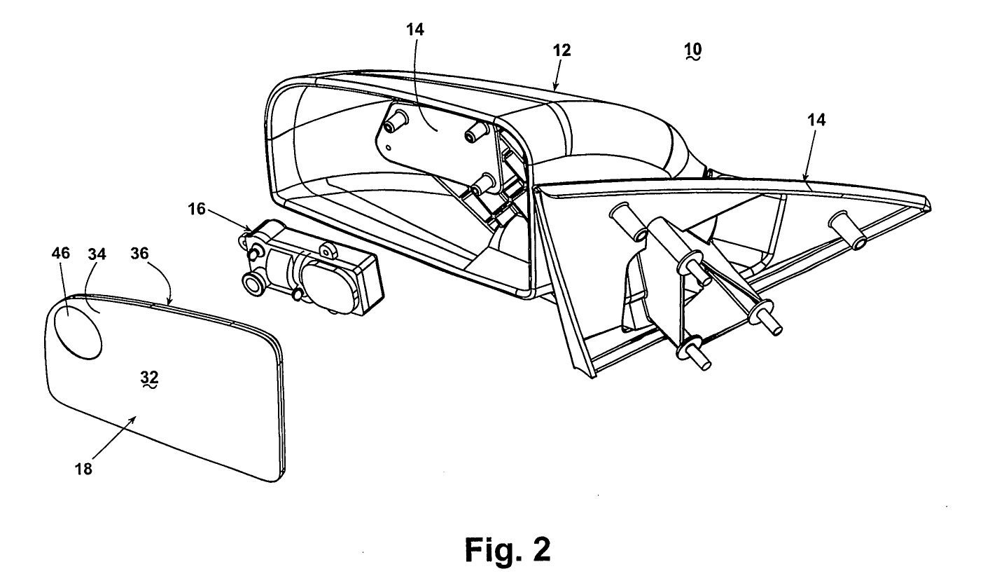

A coated plate mirror assembly 10 according to a first embodiment of the invention is shown in FIGS. 1 and 2. The mirror assembly 10 comprises a housing assembly 12 enclosing a generally conventional mounting bracket assembly 14, a generally conventional adjustment assembly 16 (shown as a tilt actuator assembly), a reflective element 18, and a base assembly 20 for attaching the mirror assembly 10 to a motor vehicle (not shown). The housing assembly 12 is a generally conventional rearview mirror housing assembly for an automotive vehicle. The mounting bracket assembly 14 mounts the adjustment assembly 16 which, in turn, mounts the reflective element 18. The adjustment assembly 16 controls the vertical and horizontal sight adjustment of the reflective element 18. Although a single adjustment assembly is shown, multiple adjustment assemblies can be utilized, each adjustment assembly controlling a single specific function, such as horizontal axis and vertical axis adjustment. It will also be understood that the housing assembly 12 can be pivotally or extendably mounted to the base assembly 20 as is known in the art. The adjustment assembly 16 is preferably interconnected to a user interface, typically located within the vehicle, for performing the adjustment of the reflective element 18.

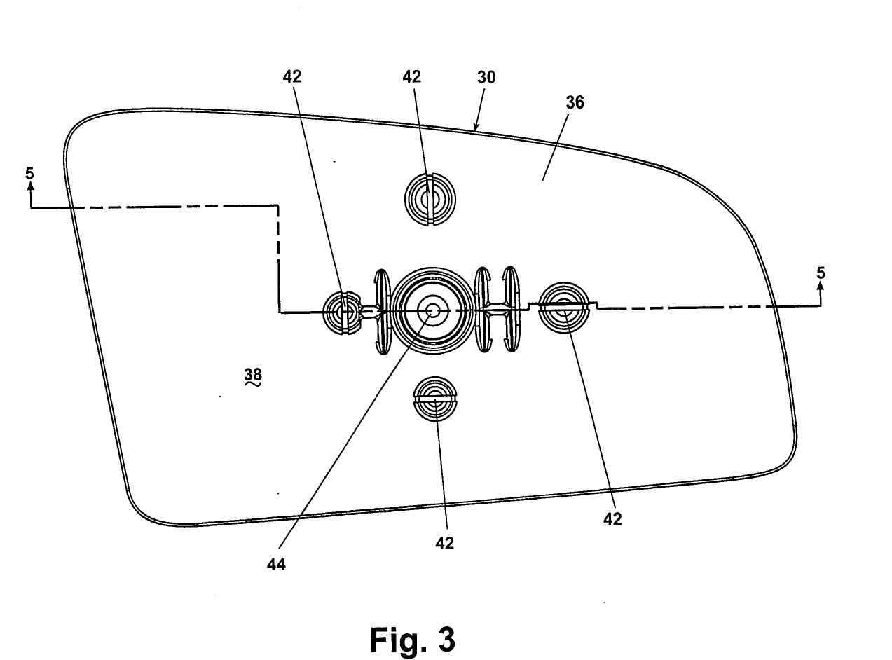

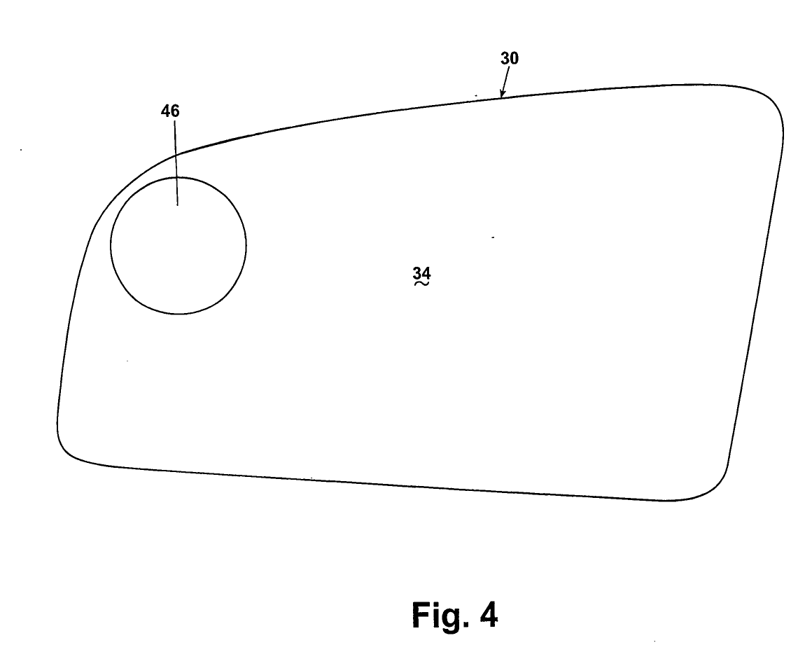

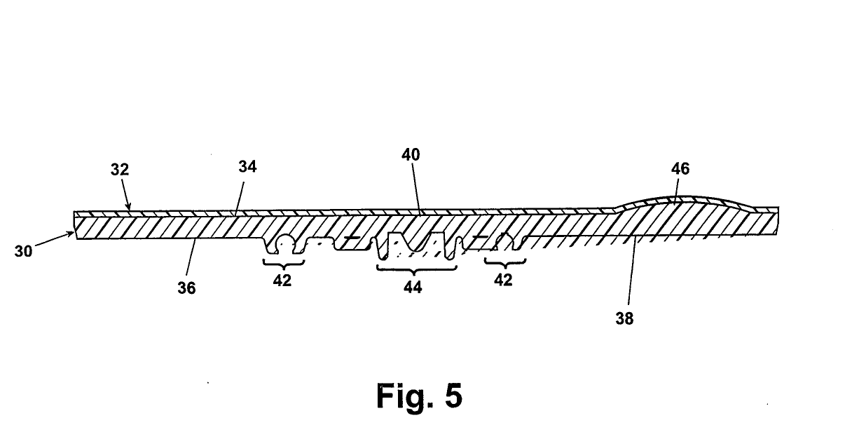

As shown in FIGS. 3-6, the reflective element 18 comprises a mounting plate 30 and a reflective film 32. The mounting plate 30 has an obverse side 34 and a reverse side 36. The reverse side 36 comprises a mounting surface 38 having a plurality of adjustment sockets 42 and a pivot socket 44 operably communicating with the adjustment assembly 16. The obverse side 34 has a mirror surface 40 to which is attached the reflective film 32. The mounting plate 30 is shown in the figures as a generally flat plate. However, the mounting plate 30 can alternatively have an aspheric, hyperbolic, parabolic, or concave profile. A portion of the mirror surface 40 can also comprise a supplemental reflective surface, such as a convex surface 46, shown in FIGS. 1-2 and 4-6 as a circular area in the upper outer corner of the reflective element 18. With the reflective film 32 applied, the convex surface 46 provides a “fish-eye” view to the rear of the vehicle to eliminate the “blind spot” experienced by the driver. Alternatively, the mounting plate 30 can be divided into a plurality of sections having one or more of an aspheric, hyperbolic, parabolic, concave, or convex profile.

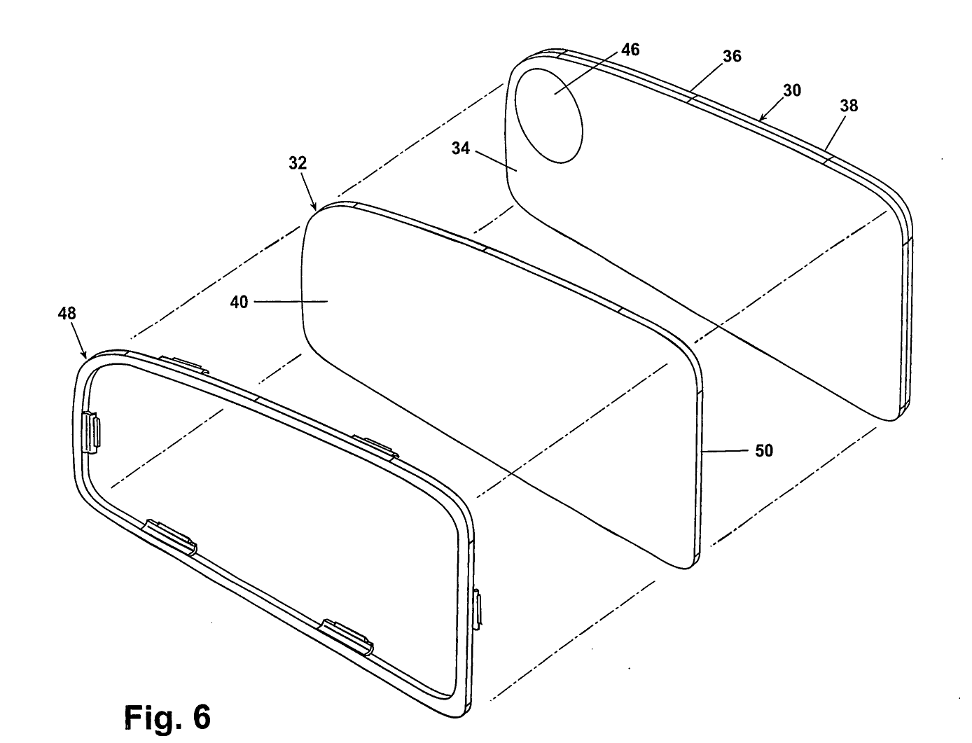

The reflective film 32 can also be covered by a bezel 48 (FIG. 6) to protect the edges of the reflective film 32 and prevent the reflective film 32 from separating from the mounting plate 30, and provide a “finished” appearance to the reflective element 18. It will be understood that it is not a limitation as to which side of the mounting plate 30 the reflective film 32 is applied. The film 32 can be applied to either the obverse or the reverse side of the mounting plate 30 without departing from the scope of this invention. Of course, if the reflective film 32 is mounted to the reverse side of the mounting plate 30, the mounting plate 30 will be fabricated from a transparent material. The reflective film 32 can be attached to the mounting plate 30 in any known manner, and the particular method of attachment shall not be construed as limiting on the invention.

The reflective film 32 is a thin, flexible, polymer-based film having reflective properties, such as the multi-layer reflective film disclosed in U.S. Pat. No. 6,352,761, issued Mar. 5, 2002, and assigned to 3M Innovative Properties Co., St. Paul, Minn., which is incorporated herein by reference. The reflective film 32 is capable of transmitting light having a diffused quality from a light source located on the side of the film 32 opposite the reflective surface. The reflective film 32 is attached to the obverse side 34 of the mounting plate 30 using a suitable process to avoid imperfections in the image provided by the reflective element 18, and to conform the film 32 to the convex surface 46.

The mounting plate 30 comprises a polymeric material capable of being fabricated with planar surfaces having minimal surface imperfections, such as “read-through” and waviness, which can manifest themselves into optical imperfections in the reflection image. A variety of synthetic resin materials, including thermoplastics, can be used to make the mounting plate 30. One such preferable material is that formed by the gas-injected MuCell technology owned by Trexel Inc. which virtually eliminates the waviness and “read-through” effects while providing a virtually smooth, warp-free surface. A reduction in weight is achieved with the use of the reflective film 32 and the elimination of several of the elements contained in the prior art multi-piece assembly, particularly the glass elements. Further weight reductions are obtained by the use of the gas-injected technology (such as MuCell) which produces a mounting plate 30 with a core having a generally uniform distribution of microscopic voids or cells (i.e. “bubbles”). The mounting plate 30, therefore, weighs less than if it was made from a solid polymeric member. It is contemplated that weight reductions of as much as an additional twenty percent of the overall weight of the mounting plate 30 can be achieved.

It will be understood that other molding techniques as well as other synthetic resin forming techniques and materials can be used without departing from the scope of this invention. For example, the mounting plate 30 can be made from an extrusion. Further, the mounting components for attaching the mounting plate 30 to the mirror actuator can be made as separate components and mechanically attached to the mounting plate 30.

For mirror defogging and defrosting functions, an electric-powered heater pad comprising a thin panel having integrated heating elements and a shape complementary to the shape of the mounting plate can be inserted between the mirror surface 40 of the mounting plate 30 and the reflective film 32. The heater pad can be selectively energized by the vehicle's 12-volt DC power supply and a suitable controller operable by the vehicle operator.

The mounting plate 30 can also be comprised of a self-regulating, electrically-conductive, heat-generating plastic such as the Step-Heat plastic marketed by High Sierra Technical of Austin, Tex., and capable of being powered and operated by the vehicle's 12-volt DC electrical system. Alternatively, a heat-generating layer capable of being powered and operated by the vehicle's 12-volt DC electrical system can be introduced into the reflective element 18, such as sandwiched between the mounting plate 30 and the reflective film 32, or attached to the reverse side 36 of the mounting plate 30. The heat-generating layer can comprise a heat-generating plastic, or a thin layer of metal. This material will provide the mirror assembly 10 with defogging and deicing capabilities. As an alternative, a clear heater assembly, such as that shown in commonly-owned PCT Application No. WO 99/40039, published Aug. 12, 1999, which is incorporated herein by reference, can be employed to provide heat to the assembly.

The reflective film 32 is attached to the mounting plate 30 through generally conventional laminating operations, with the film 32 being stretched during the application process to ensure “optical acceptance” and an accurate reflection image, such as a 1% maximum distortion specification pursuant to Toyota Engineering Standard TSC3901G. For example, a clamp-frame can be used on an injection mold which stretches the film in two directions. Alternatively, the injection mold can be provided with a profile groove so that either when the mold is closed, or when the plastic is injected, the film is stretched. Because of the method of using a thin flexible film 32, and stretching the film 32 across the mounting plate 30, the film 32 can be applied to both the flat, obverse side 34 of the panel 30 and the curved, convex surface 46 in a single operation to provide a smooth, unbroken reflective surface.

Alternatively, the reflective element 18 can comprise a conventional coated mirror, with the supplemental reflective surface 46 comprising a separate convex surface attached to the mounting plate 30 and having the reflective film 32 applied only to the supplemental reflective surface 46. As well, both the mounting plate 30 and the supplemental reflective surface 46 can have the reflective film 32 applied separately to each piece, followed by attachment of the supplemental reflective surface 46 to the mounting plate 30 to form the finished reflective element 18.

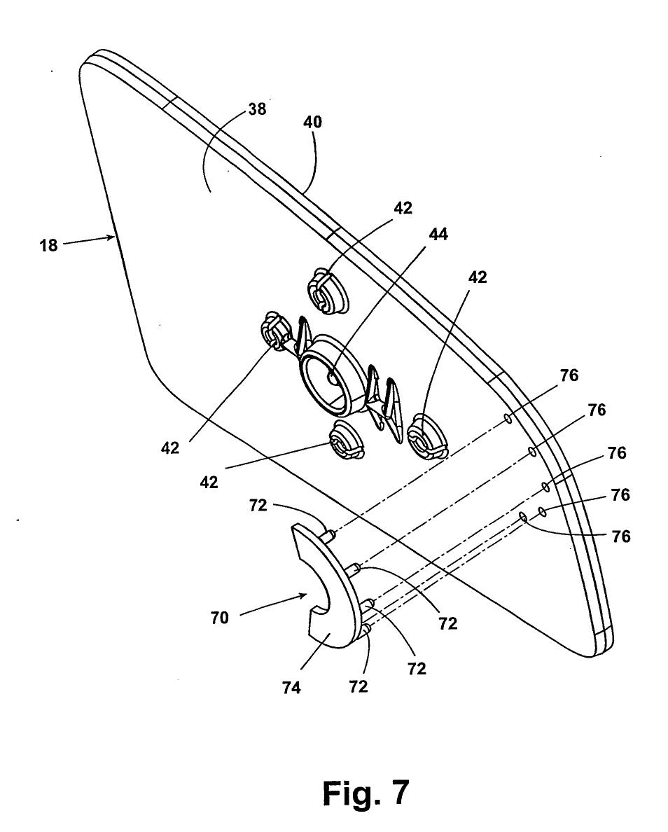

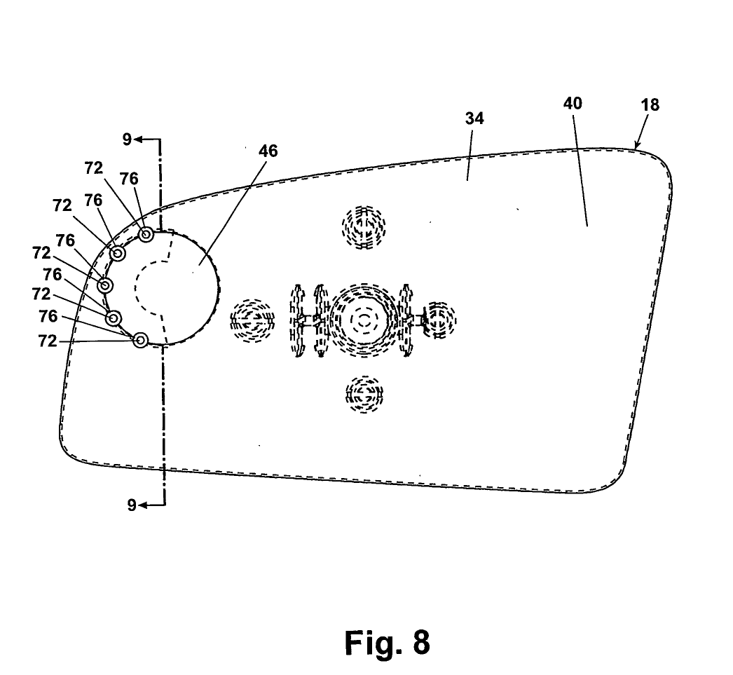

Referring to FIGS. 7-9, a second embodiment of the rearview mirror assembly is shown comprising a light assembly 70 comprising a plurality of lighting elements 72 in a frame 74, shown for purposes of illustration as arranged in a generally semicircular configuration. The lighting elements 72 are adapted to lie along the circumference of the convex surface 46, which will highlight and draw the driver's attention to the convex surface 46. The use of the reflective film 32 provides a plurality of individual reflective surfaces for the lighting elements 72 for magnifying the intensity of the light therefrom. These reflective surfaces are readily fabricated through the use of the film 32.

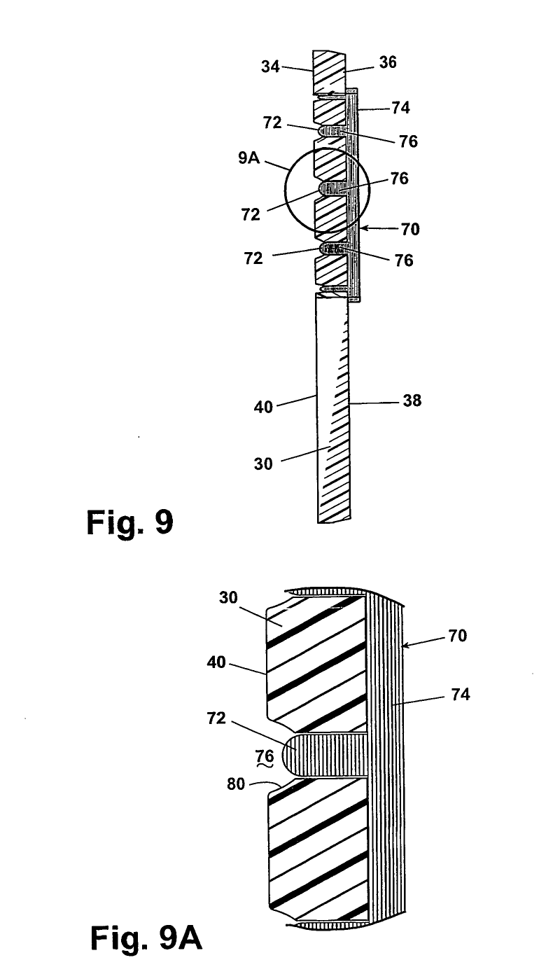

The lighting elements 72, such as small light bulbs or light-emitting diodes, are operably interconnected to the vehicle's 12-volt DC electrical supply and control systems for selective operation of the light assembly 70. As an example, the light assembly 70 can be electrically interconnected with the vehicle's turn signals to indicate the operation of the turn signals when the driver uses the rearview mirror. In the preferred embodiment, a plurality of lighting element apertures 76 is provided along a portion of the circumference of the convex surface 46. As shown in FIGS. 9 and 9A, each lighting element aperture 76 comprises a cylindrical portion 78 and a conical portion 80. When the reflective film 32 is applied to the mounting plate 30, the reflective film 32 will be drawn into and assume the profile of the conical portion 80.

As shown in FIGS. 7 and 9, the light assembly 70 is attached to the mounting plate 30 from the reverse side 36 with the lighting elements 72 inserted into the lighting element apertures 76. Because of the reflective film 32, the conical portion 80 comprises a conical reflective surface, thereby concentrating and magnifying the light from the lighting elements 72. The light will also be projected from the reflective element 18, thereby increasing the visibility of the lighting elements 72.

Alternatively, the reflective film 32 can be attached to the mounting plate 30 so that the reflective film 32 bridges over the lighting element aperture 76 so that the lighting elements 72 are positioned behind the reflective film 32. Because the reflective film 32 is capable of transmitting light having a diffused quality, the image observed through the film 32 will be muted.

The unique one-piece vehicle mirror with a polymeric reflective film element comprises fewer components than a conventional multi-piece mirror assembly, is lighter weight, and can be fabricated and assembled with fewer components and fewer steps, thereby saving costs and contributing to the improved gas mileage of the automotive vehicle of which it is a part. The use of a single reflective film element enables the use of a mounting panel which is lighter and potentially thinner, thereby enabling the use of thinner strengthening and supporting elements. This feature, along with the use of a thermoplastic foam-type polymer, reduces “read-through” and planar imperfections which can distort the reflection image. The use of a heat-generating plastic eliminates the separate heating element required for a conventional multi-piece mirror assembly. An integrated convex “blind spot” element eliminates the need to fabricate and assemble a separate “blind spot” mirror. The use of the polymeric reflective film element enables the use of the lighting assembly which can be mounted coplanar with or forward of the reflective surface, thereby eliminating transmission losses occurring with lights that are mounted behind glass or plastic panels.

It should also be noted that making the reflective portion (i.e., the film 32) and the mounting portion (i.e., the plate 30) out of complementary materials makes the mirror assembly fully recyclable without intervening reclamation steps to recover non-recoverable materials. Also, making the mirror assembly from fully complementary materials provides additional benefits in that the shrinkage and expansion rates due to ambient temperature changes is relatively equal so that distortion in the resultant mirror image is not encountered.

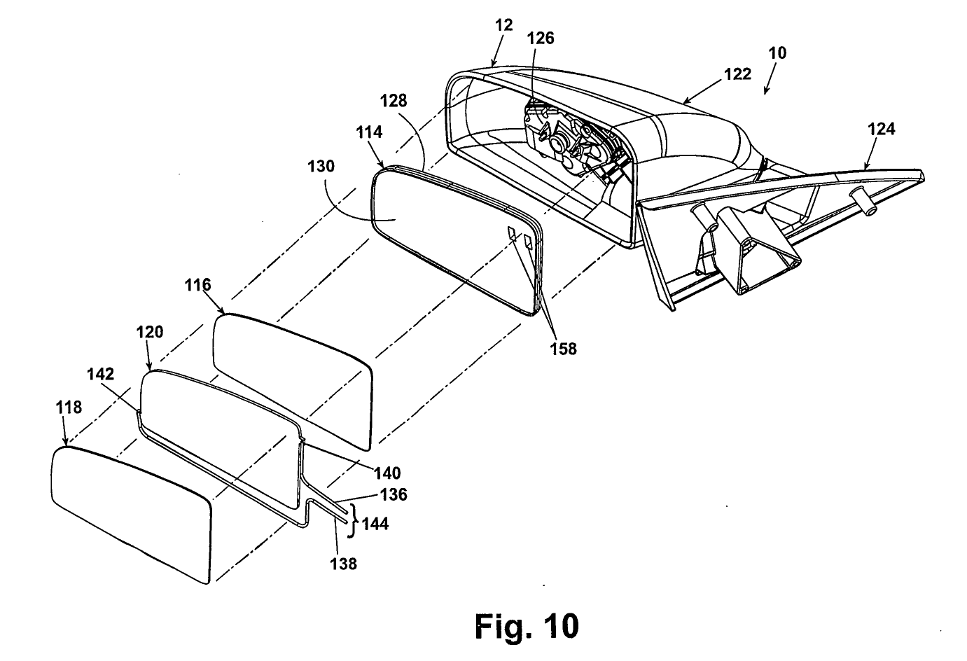

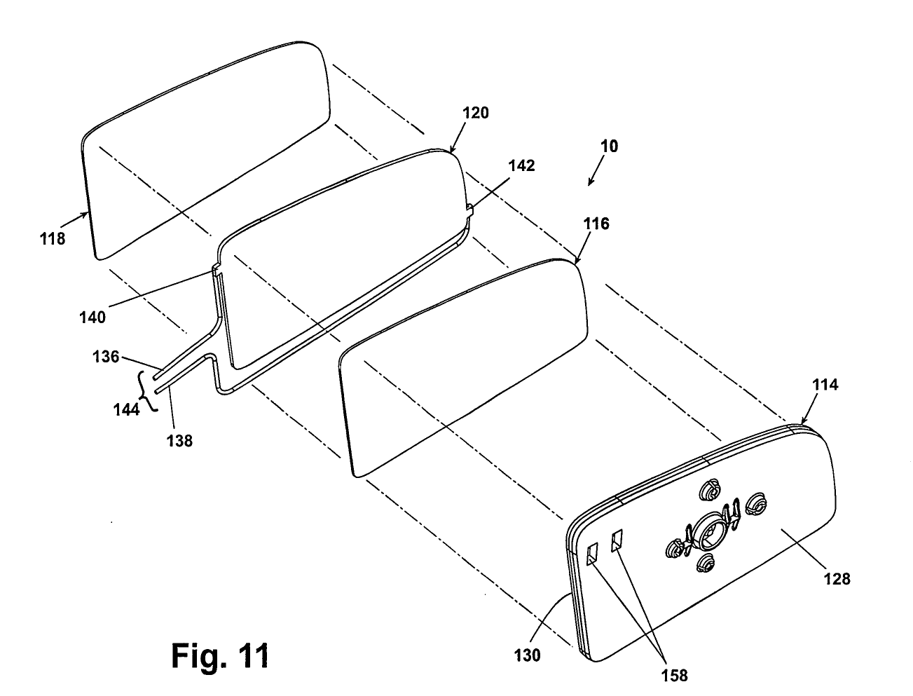

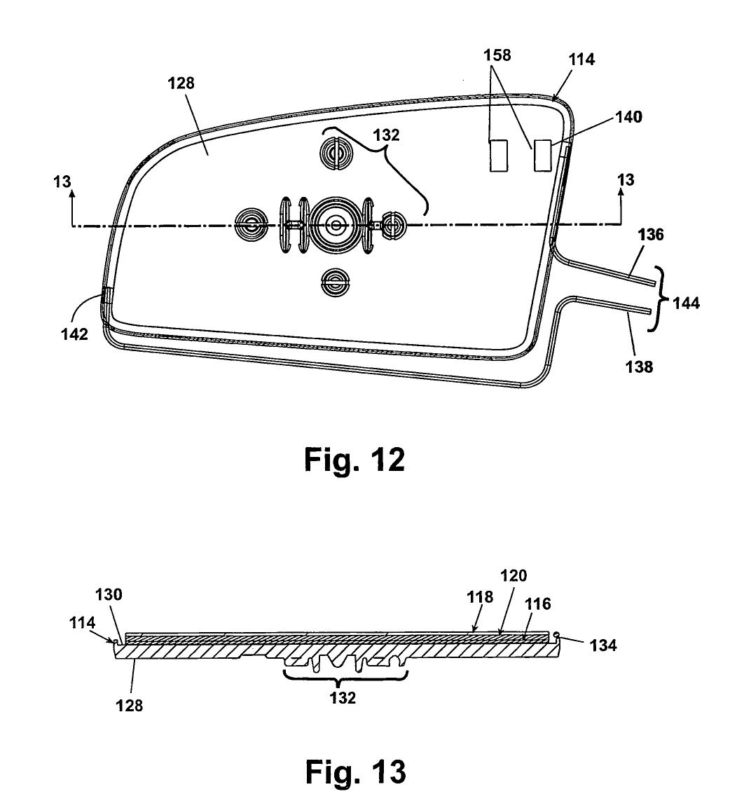

Turning now to FIGS. 10-13, a third embodiment of the mirror assembly 10 is shown having several of the previously-described elements and additionally comprising a mounting plate 114, a first glass element 116, a second glass element 118, and a chromomorphic, i.e. color-changing, polymeric element 120. Thus, like numerals will be used to identify like elements.

It will be understood that, while a mirror assembly 10 suitable for attachment to an exterior portion of a vehicle, such as in a door-mounted rear view external mirror, is shown and described herein, the invention is equally applicable to an interior windshield-mounted mirror assembly without departing from the scope of the invention.

As shown in FIGS. 10-13, the mirror assembly 10 preferably comprises a mirror housing 122 mounted to a base 124. The mirror assembly 10 can also include an actuator 126 preferably provided for accomplishing typical pitch-and-roll adjustment of the mirror components 114-120 as is known in the a it. The actuator 126 is preferably interconnected to a user interlace, typically located within the vehicle, for performing the adjustment of the mirror components 114-120.

The mounting plate 114 preferably has a forward-facing side 128 and a rearward-facing side 130. The forward-facing side 128 preferably has suitable mounting components 132 for interconnecting the mounting plate 114 to the actuator 126 so that adjustments imparted by the actuator 126 are transmitted to the mounting plate 114 by the mounting components 132 to accomplish the pitch-and-roll adjustment of the mirror components 114-120. The mounting components 132 are interconnected to the actuator 126 in a known manner and, thus, further description of the interaction between the mounting components 132 of the mounting plate 114 and the actuator 126 is not necessary. The rearward-facing side 130 can have a bezel 134 (FIG. 13) thereon provided around the periphery of the mounting plate 114 and generally extending in a rearward direction to provide protection to the mirror components 114-120 as assembled.

The first and second glass elements 116, 118 are generally transparent bodies, preferably made of glass, and have a periphery generally corresponding to that of the mounting plate 114 and generally sized to fit within the periphery of the bezel 134 (if provided on the rearwardly-facing side 130 of the mounting plate 114). One of the first and second glass elements 116, 118, preferably the inner surface of the second glass element 118, is provided with a reflective coating thereon, such as the reflective film 32 described previously herein, to provide the rear reflective function of the mirror assembly 10.

The chromomorphic polymeric element 120 is preferably made from a material that is generally transparent in a first, non-activated state and that turns a generally translucent, preferably darkened, color when catalyzed into a second, activated state. Examples of chromomorphic polymeric materials are shown in U.S. Pat. Nos. 5,501,945, 6,165,234 and 6,286,423 all of which are incorporated herein by reference. The particular chromomorphic polymeric material used in the polymeric element 120 is not critical to the invention and many chromomorphic polymers known in the art are entirely suitable for use as the polymeric element 120 in the inventive mirror assembly 10 described herein. One example of a suitable chromorphic material is a thermochromic (i.e. changing color with changes in temperature) dye manufactured by Color Change Corporation of Streamwood, Ill.

The polymeric element 120 shown in FIGS. 10-13 is preferably an electrically activated, chromomorphic polymer. First and second terminals 136, 138 are electrically interconnected to first and second terminals 140, 142 comprising a pair of tab-like extensions of the polymeric element 120 on opposite ends thereof. Opposite end portions of the first and second terminals 136, 138 (shown generally by reference numeral 144) are preferably connected to a suitable on-board vehicle controller (not shown), such as a programmable microprocessor, which provides appropriate signals through the first and second terminals 136, 138 to oscillate the polymeric element 120 between the first, transparent state and the second, darkened state as required by the operating conditions of the vehicle.

As contemplated by this invention, the first and second terminals 136, 138 are preferably maintained in an uncharged state, thus delivering no current to the polymeric element 120 (via the first and second terminals 140, 142). Once a chromomorphic (or, i.e., an automatic dimming) feature is required or requested by the controller, the controller delivers current to the first and second terminals 136, 138 via its connections 144 to the first and second terminals 140, 142 on the polymeric element 120. This delivery of current preferably oscillates the polymeric element 120 to the second, darkened state, causing the chromomorphic polymer making up the polymeric element 120 to darken to its translucent, colored hue. As would be apparent to one skilled in the art, removal of the current through the first and second terminals 136, 138, and therefore to the terminals 140, 142, returns the chromomorphic polymer to its first, transparent state.

The mirror assembly 10 is assembled in generally conventional manner. The actuator 126 is mounted within the mirror housing 122 and is interconnected to the mounting portions 132 on the forward-facing side 128 of the mounting plate 114. The first and second glass elements 116, 118 are preferably formed as a subassembly with the chromomorphic polymeric element 120 sandwiched therebetween.

The first and second glass elements 116, 118 with the polymeric element 120 therebetween are preferably mounted to the rearward-facing side 130 of the mounting plate 114 in a known fashion, such as by adhesive or ultrasonic welding. As can be seen in FIG. 13, when the first and second glass elements 116, 118 and the chromomorphic polymeric element 120 are mounted to the rearward-facing side 130 of the mounting plate 114, the polymeric element 120 is uniquely disposed to provide a dimming function to the reflective coating, such as provided on the first glass element 116. As can be seen, as the polymeric element 120 is shifted between the first and second states, the transparent and translucent color, respectively, of the particular states of the polymeric element 120 provide appropriate dimming and non-dimming to the mirror assembly 10.

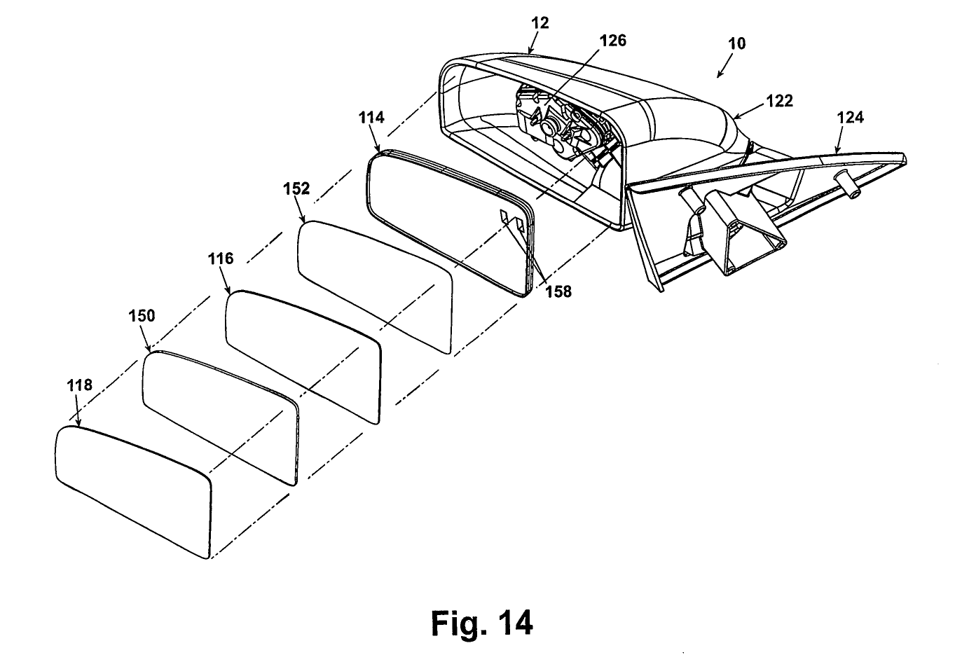

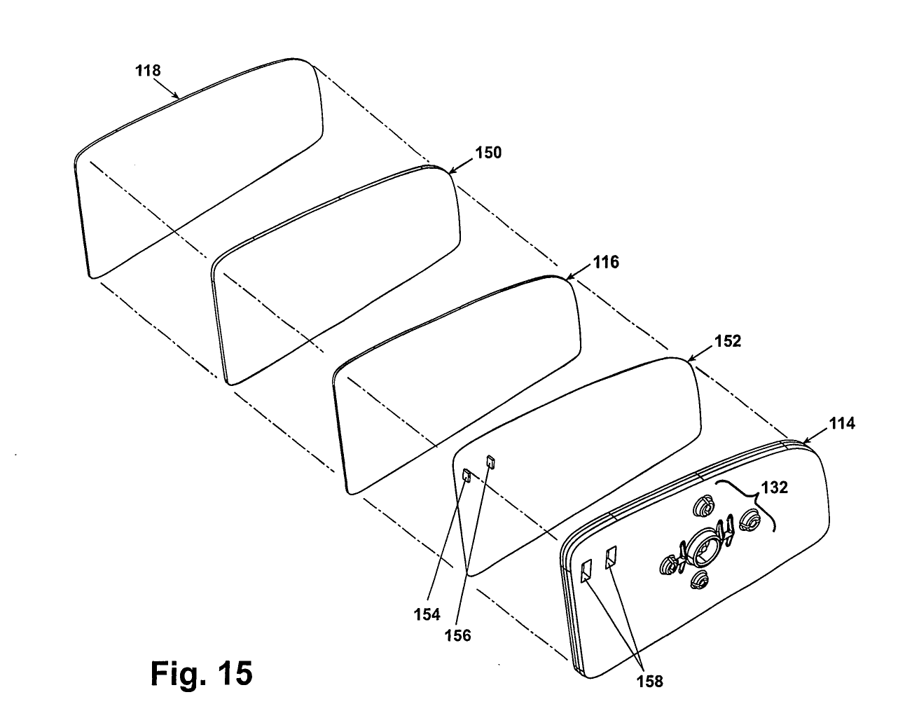

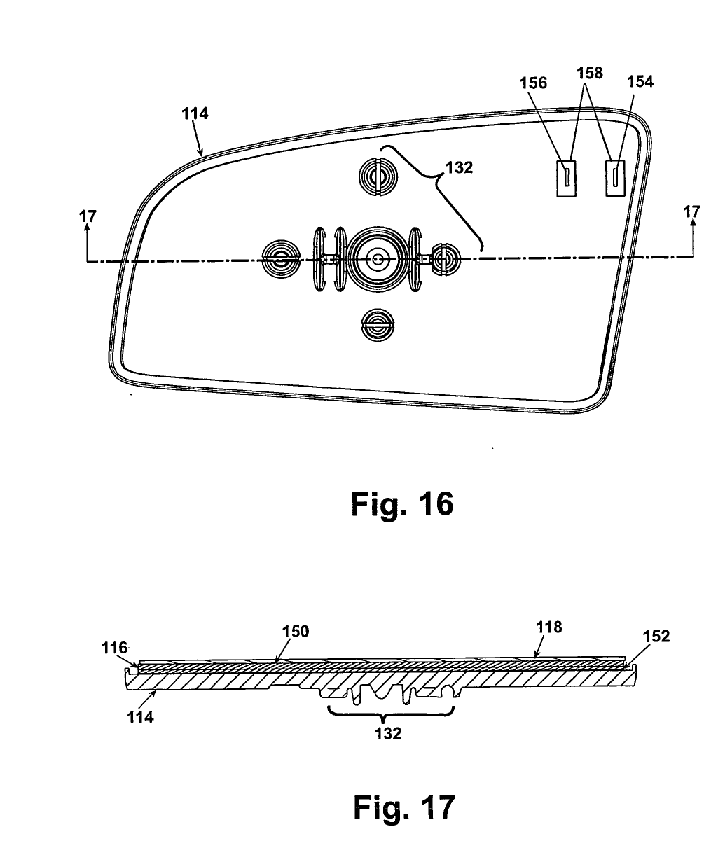

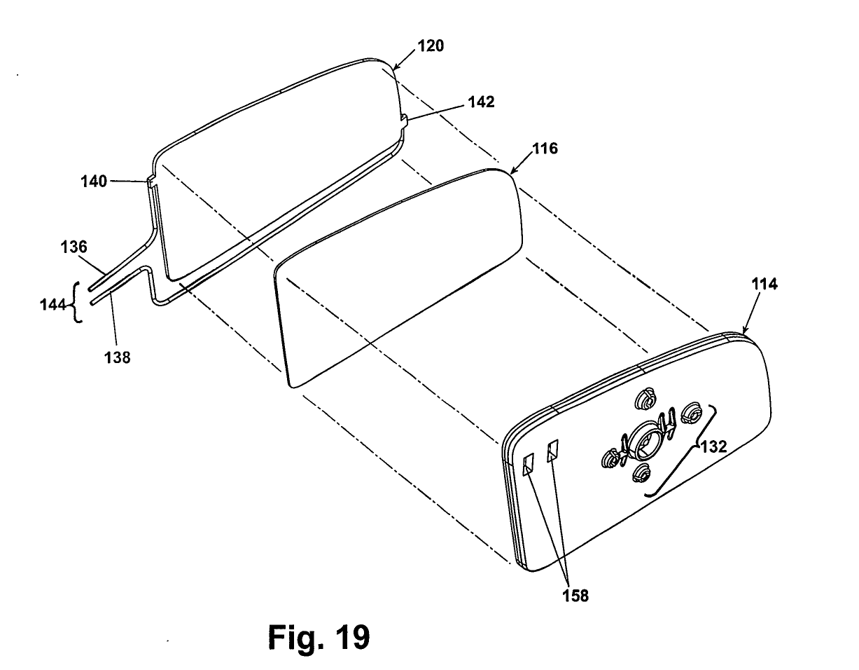

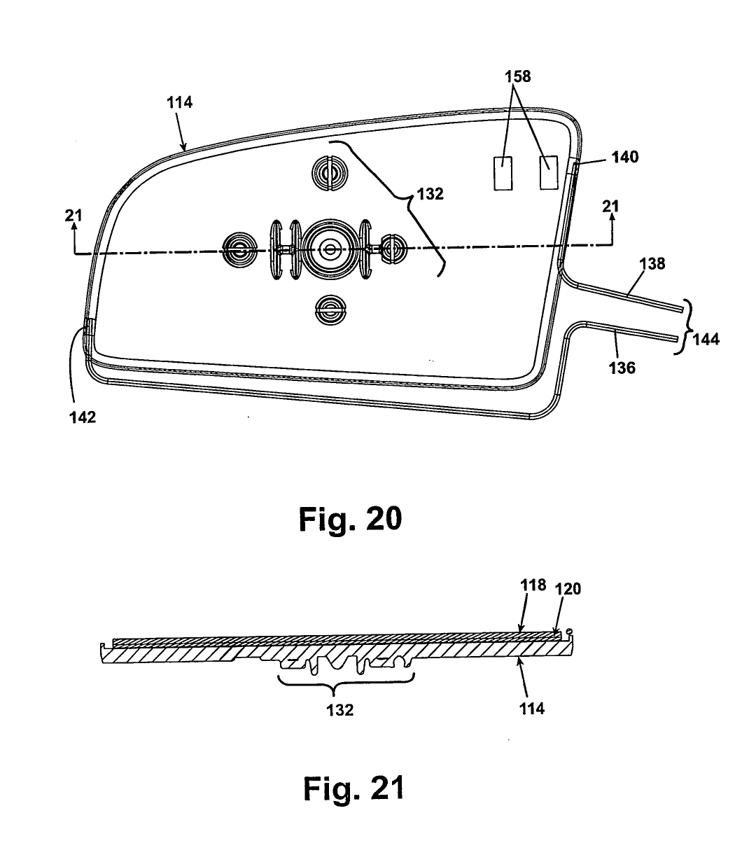

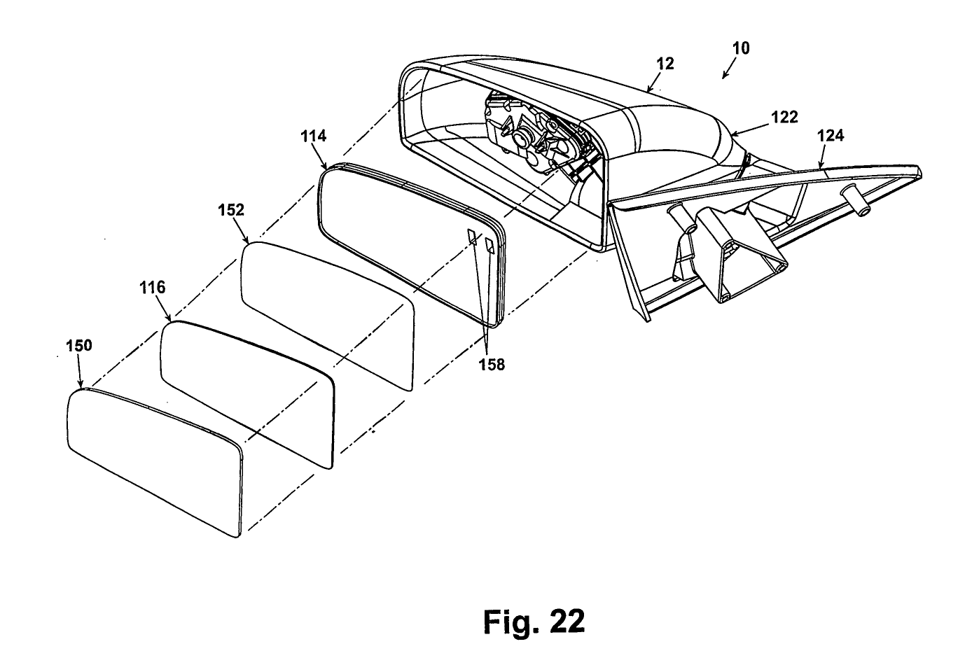

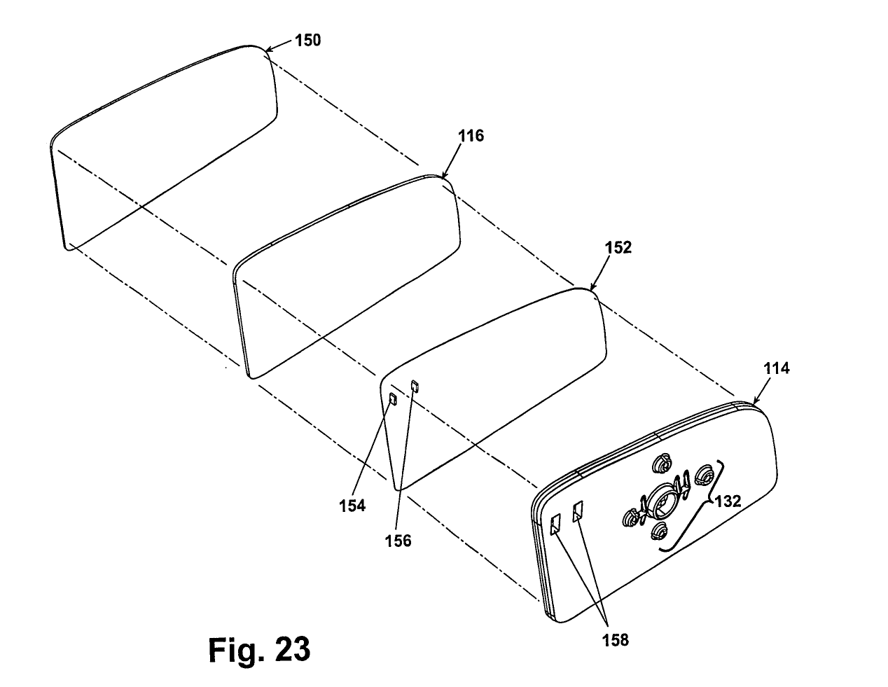

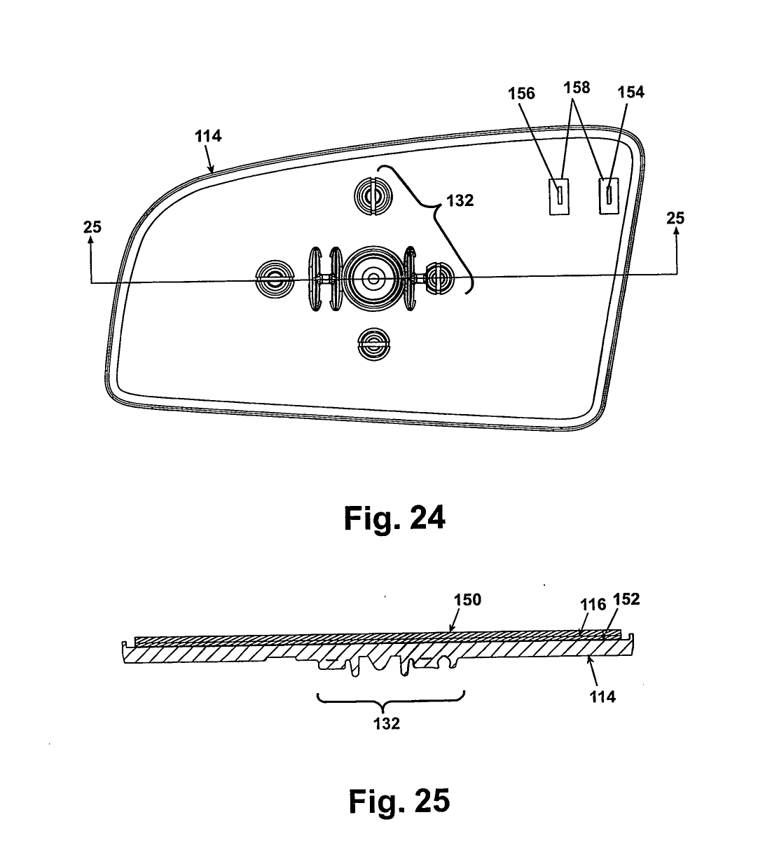

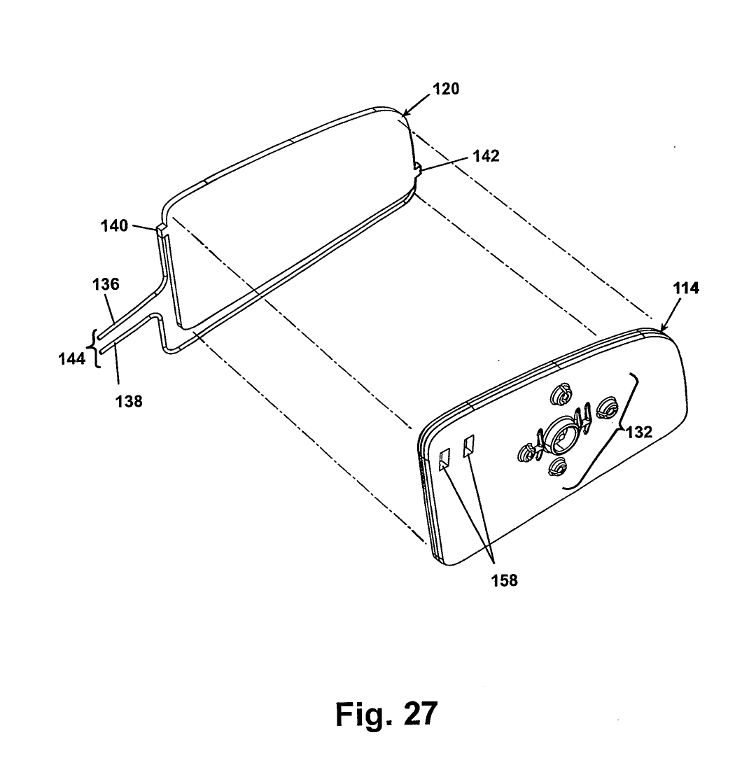

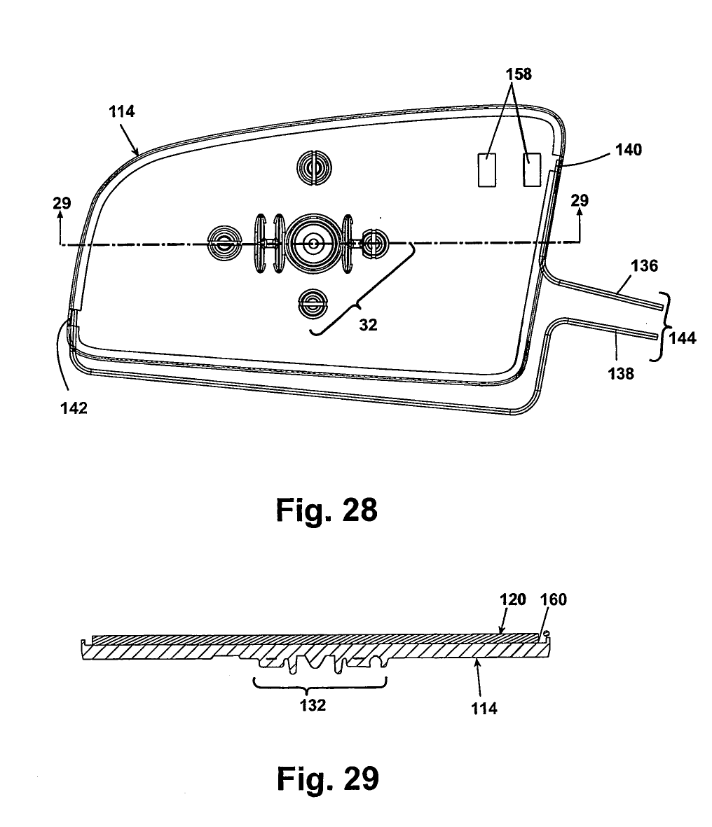

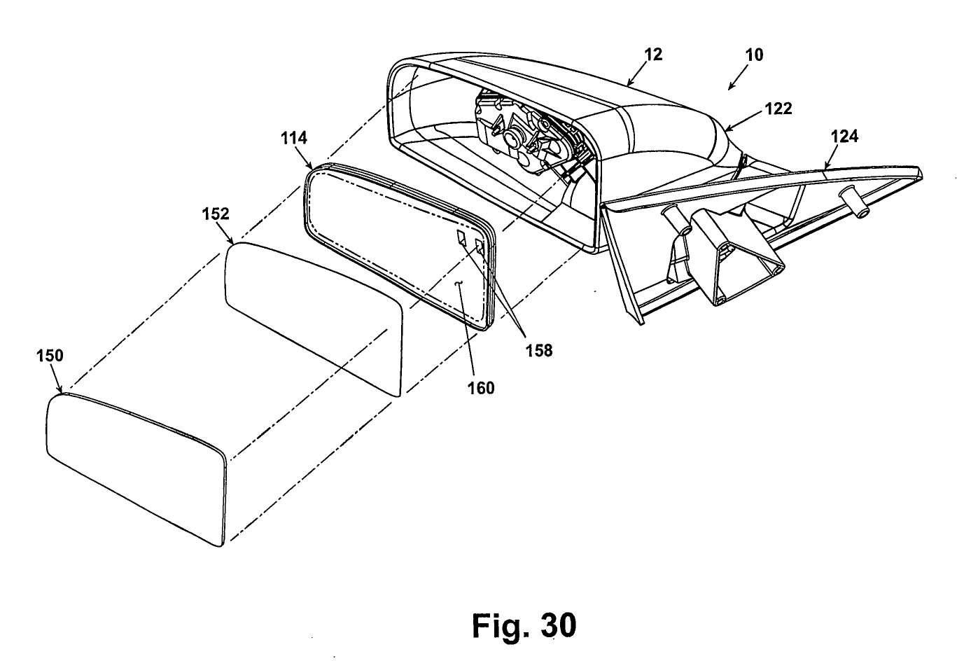

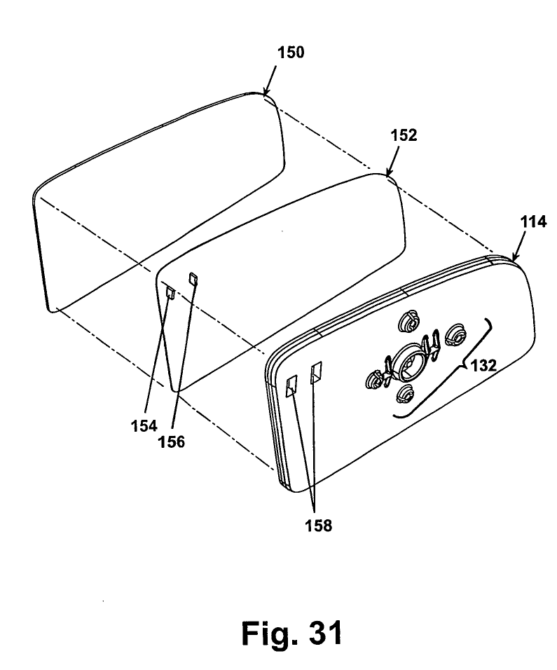

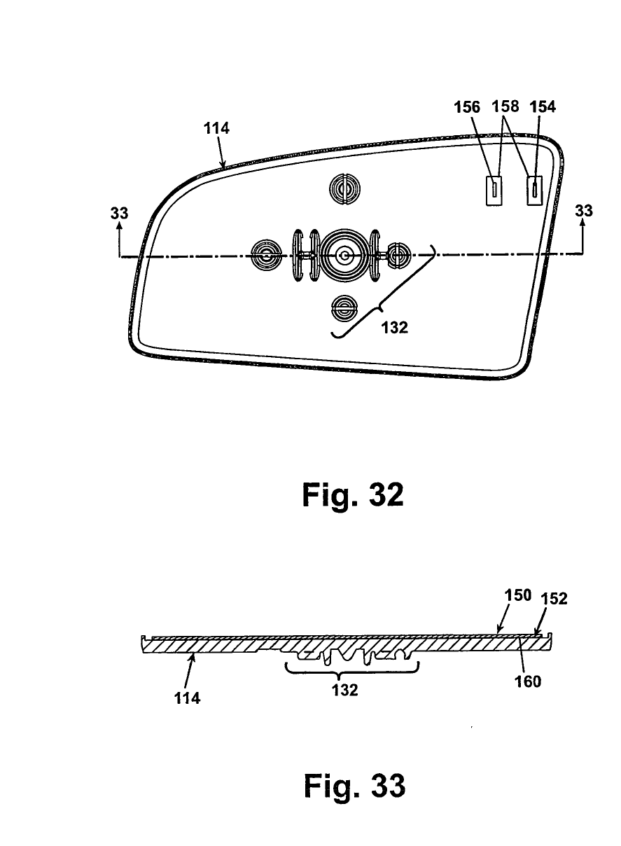

The structure, assembly and operation of the fourth to eighth embodiments of FIGS. 14-33 are very similar to the third embodiment shown in FIGS. 10-13. Therefore, the structural differences between the different embodiments will be identified, but a detailed re-description of each of the fourth to eighth embodiments of FIGS. 14-33 will not be provided. It will be understood that like elements that are common to the multiple embodiments of the mirror assembly 10 described herein are identified with like reference numerals on the drawings, obviating the re-description of the elements of the fourth through eighth embodiments.

With reference to FIGS. 14-17, the fourth embodiment of the mirror housing 10 is very similar to the third embodiment in FIGS. 10-13 except that the electrically-activated, chromomorphic polymeric element 120 has been replaced with a thermally-activated chromomorphic polymeric element 150. The thermally-activated chromomorphic polymeric element 150 is located between the first and second glass plates 116, 118 as in the third embodiment of FIGS. 10-13. One additional element is provided in the fourth embodiment shown in FIGS. 14-17 of the mirror housing 10 which can be an optional element for the third embodiment of the mirror housing 10. A heater 152, and preferably a clear heater as shown in PCT Application No. WO 99/40039, published Aug. 12, 1999, which is incorporated herein by reference, is provided to heat the polymeric element 150 in accordance with a suitable, predetermined signal from a controller.

The heater 152 preferably has first and second terminals 154, 156 which are interconnected to a controller; as in the third embodiment, via recesses 158 in the mounting plate 114 to electrically interconnect the heater 152 to the onboard vehicle power supply and to the controller. Thus, activation of the heater 152 heats the first and second glass plates 116, 118, and the polymeric element 150 located therebetween. As the polymeric element 150 is raised in temperature, it is moved from its first, transparent state to its second, darkened state, and performs the dimming feature to the first and second glass plates 116, 118 as in the third embodiment.

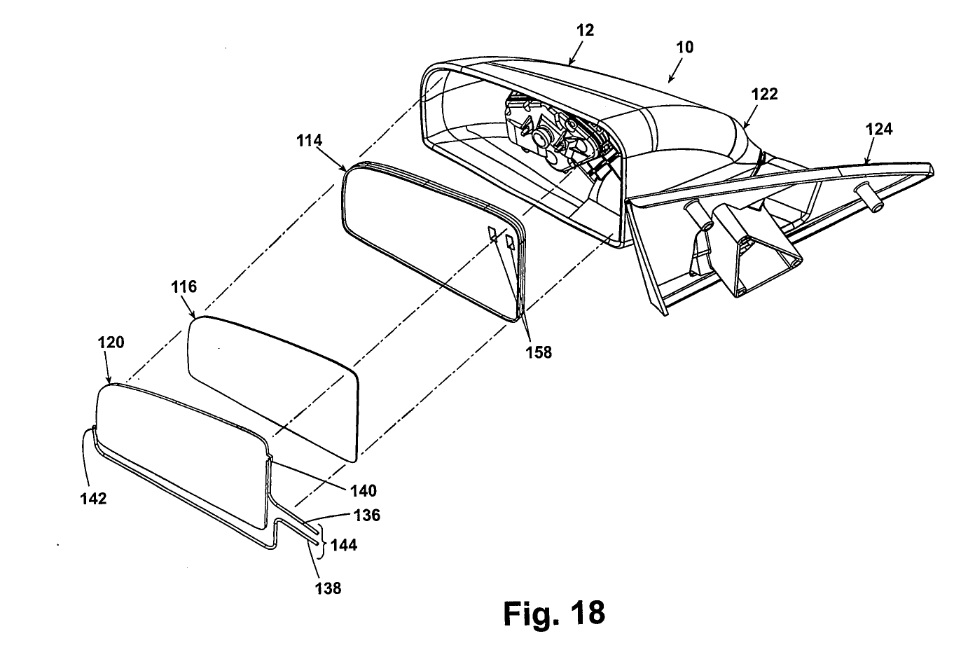

The fifth and sixth embodiments of FIGS. 18-21 and 22-25, respectively, are variations on the third and fourth embodiments, respectively. As can be seen from FIGS. 18-21 and 22-25, the fifth and sixth embodiments are a single-glass-pane version of the third and fourth embodiments. Specifically, the fifth and sixth embodiments do not have the second glass element 118 but, rather, these embodiments have only the first glass element 116 (preferably with a reflective coating thereon) disposed between the chromomorphic polymeric element and the mounting plate 114.

In the fifth embodiment, the chromomorphic polymeric element is an electrically activated, chromomorphic polymeric element identified by reference numeral 120. In the sixth embodiment, the chromomorphic polymeric element is a thermally-activated chromomorphic polymeric element identified by reference numeral 150. It can also be noted that a heater 152 is provided in the sixth embodiment to provide a catalyst heat source for the thermally-activated chromomorphic polymeric element 150.

It will be understood that, since the polymeric element 120/150 in the fifth and sixth embodiments comprises an exterior surface of the mirror assembly 10 which is exposed to the elements, the polymeric element 120/150 is preferably a sufficient thickness to withstand exposure to the elements. Alternatively, the polymeric element 120/150 can be provided with an external coating of a suitable protectant to allow the polymeric element 120/150 to further withstand exposure to the elements.

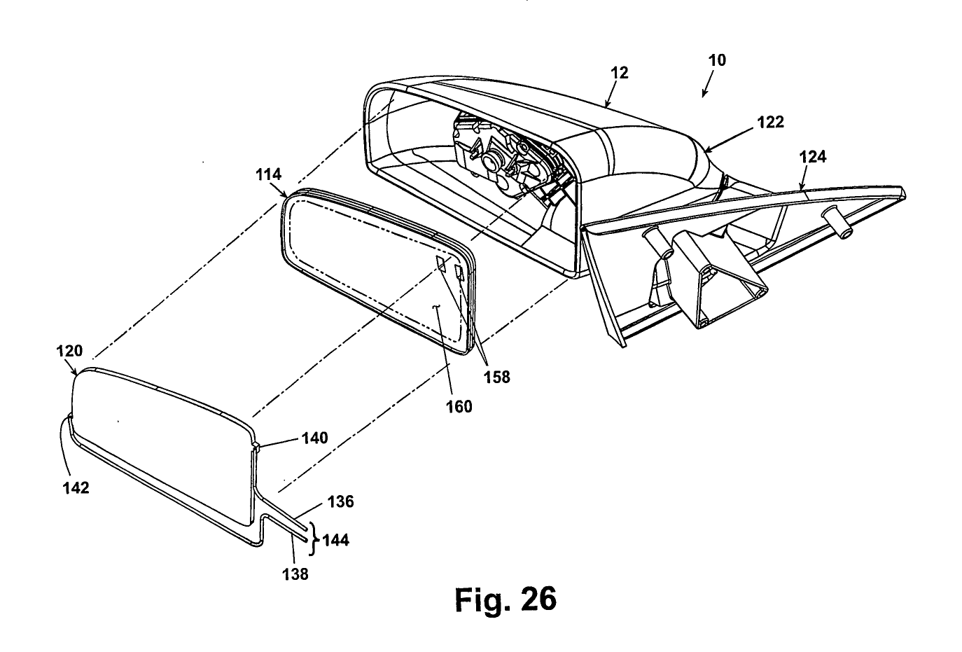

The seventh and eighth embodiments of FIGS. 26-29 and 30-33, respectively, are further variations on the third and fourth embodiments shown in FIGS. 10-13 and 14-17, respectively. As can be seen from FIGS. 26-29 and 30-33, the seventh and eighth embodiments the simplified mirror assemblies with both glass elements 116, 118 removed. In the seventh and eighth embodiments, the mounting plate 114 has a reflective film 160 mounted directly thereon as previously shown and described with respect to the reflective film 32—no glass elements are utilized for the seventh and eighth embodiments. In the seventh embodiment, an electrically activated, chromomorphic polymeric element 120 is provided over the reflective film 160. In the eighth embodiment, a thermally-activated, chromomorphic polymeric element 150 is provided over the reflective film 160. As in the previous embodiments, which relate to the thermally-activated chromomorphic polymeric element 150, a heater 152 is provided between the chromomorphic polymeric element 150 and the reflective film 160 on the mounting plate 114. As we have the fifth and sixth embodiments, the polymeric element 120/150 is preferably a sufficient thickness to withstand exposure to the elements, or is provided with an external coating of a suitable protectant to allow the polymeric element 120/150 to withstand exposure to the elements.

Alternatively, the heater 152 can be eliminated by utilizing a heat-generating plastic for the mounting plate 114, such as the Step-Heat plastic marketed by High Sierra Technical of Austin, Tex., as previously disclosed herein with respect to the mounting plate 30. The mirror assembly 10 will thus comprise the mounting plate 114, the reflective film 160, and the polymeric element 150. Indeed, in each of the previous embodiments disclosed herein utilizing a thermally-activated chromomorphic polymeric element 150, the heater 152 can be eliminated and the mounting plate 114 fabricated of a heat-generating plastic.

It will be understood that the chromomorphic polymeric elements 120/150 described herein can be any suitable chromomorphic polymer of any of a number of materials and activation types. For example, in addition to the electrically- and thermally-activated, chromomorphic polymers described herein, the chromomorphic polymers can also be activated by light (photochromic), chemicals (chemochromic), vibration (piezochromic), water (aquachromic), and the like. For example, if a photochromic, chromomorphic polymer were used, the need for an on-board controller may be eliminated. If a chemochromic, chromomorphic polymer were used, the controller can be modified to apply one or more catalyst chemicals to oscillate the chromomorphic polymer between its states if a piezochiomic, chromomorphic polymer were used, the mirror assembly 10 could be modified to include an appropriate vibratory actuator or, alternatively, the actuator 126 could be modified to include a controllable vibratory element thereon. As would be apparent to one skilled in the art, the invention described herein contemplates multiple types of suitable chromomorphic polymeric elements without departing from the scope of this invention and the particular types of chromomorphic elements described herein should not be construed as limiting on the invention.

Several other advantages from this invention can be realized from the use of a polymeric film reflector as opposed to a conventional glass-and-chrome mirror element.

First, the polymeric film, such as the exemplary embodiment described herein, has light transmissibility qualities so that a light source positioned adjacent one side of the polymeric reflector will transmit light through the polymeric reflector through to the other side thereof. This allows a mirror system incorporating the polymeric reflector element to include such illumination-based functional components positioned within the mirror system behind the polymeric reflector such as a turn signal, assist light, reverse light, blind zone indicator and the like without requiring that an aperture be formed in the reflective element as in prior art mirror devices.

Second, the polymeric reflective film as described herein consists of nonmetallic, polymeric layers and thus is recyclable, and can be put through a reclamation process without separation from any attached mounting components.

Third, the formability and conformability of the polymeric reflective film provide distinct manufacturing advantages in attachment and mounting of the polymeric reflective film to a mirror system. In addition, the conformability properties of the film permit the polymeric reflective element to be applied to a surface with a radius of curvature, such as that used in blind zone mirror applications.

It will also be understood that, while the invention has been described with respect to a vehicular rearview mirror, the invention is equally applicable to other technology areas where a dimming feature is desired, including architectural glass. For example, a dimming architectural window can be created by simply removing the reflective film on each of the six embodiments described herein and mounting a glass pane with a chromomorphic polymeric element described herein associated therewith.

While the invention has been specifically described in connection with certain specific embodiments thereof, it is to be understood that this is by way of illustration and not of limitation. Reasonable variation and modification are possible within the scope of the foregoing disclosure and drawings without departing from the scope of the invention.

1-63. (canceled)

64. A vehicular rear-view mirror comprising:
a substrate; and
a reflective element formed by conforming an all polymer-based reflective film to said substrate.

65. The mirror of claim 64 wherein said reflective film is capable of transmitting light.

66. The mirror of claim 64 wherein said substrate is fabricated from heat-generating plastic.

67. The mirror of claim 65 wherein, when said substrate is electrically powered, heat generated by the heat-generating plastic performs at least one of a defrosting and a defogging operation on the reflective element.

68. The mirror of claim 64 wherein said substrate is electrically powered.

69. The mirror of claim 64 wherein said substrate is formed from a polymeric material.

70. The mirror of claim 64 wherein said substrate comprises a planar surface and the reflective element substantially covers the planar surface.

71. The mirror of claim 69 wherein said planar surface has minimal imperfections thereon to provide a reflection image off the reflective element with reduced visible distortion.

72. The mirror of claim 64 wherein said substrate is fabricated by a gas-injection process to provide a core having a generally uniform distribution of microscopic voids.

73. The mirror of claim 64 wherein said substrate includes a surface extending from the substrate and configured to provide a wide-angle view when covered by the reflective film.

74. The mirror of claim 72 wherein said surface is generally circular.

75. The mirror of claim 72 wherein said surface is generally convex.

76. The mirror of claim 64 comprising a heating element for at least one of defogging and defrosting the reflective element.

77. The mirror of claim 75 wherein said heating element comprises a heat-generating plastic.

78. The mirror of claim 76 wherein said substrate is at least partially fabricated of heat-generating plastic.

79. The mirror of claim 64 further comprising a blind zone reflective element provided thereon.

80. The mirror of claim 77 wherein said heat-generating plastic generates heat when electrically powered.

81. The mirror of claim 79 wherein at least a portion of the reflective element conforms to a generally convex surface formed on the substrate configured to provide a wide-angle view.

82. The mirror of claim 64 wherein said reflective film conforms both to a generally planar portion of the substrate and a generally convex portion of the substrate to provide a generally planar reflection portion and a wide-angle reflective portion.

83. A vehicular rear-view mirror comprising:
a substrate;
a reflective element formed by conforming an all polymer-based reflective film to said substrate;
wherein said substrate is formed from a polymeric material; and
wherein said reflective film is capable of transmitting light.

84. A vehicular rear-view mirror comprising:
a substrate;
a reflective element formed by conforming an all polymer-based reflective film to said substrate;
wherein said reflective film is capable of transmitting light emitted by a light-emitting device, said light emitting device being disposed to the rear of said reflective element so as to emit light through said reflective element.
